(19) United States
(12) Patent Application Publication
(10) Pub. No.: US 2026/0350945 A1
(43) Pub. Date: Nov. 5, 2026

(54) DYNAMIC IMAGE MODIFICATION WITH THREE-DIMENSIONAL ARTIFICIAL FEATURE

(71) Applicant: Walmart Apollo, LLC, Bentonville, AR (US)

(72) Inventors: Jenny Zukerman, Herzliya (IL); Neor Ozeri, Ramat Gan (IL); Geva Bidner, Modi'in (IL)

(21) Appl. No.: 19/198,569

(22) Filed: May 5, 2025

(51) Int. Cl. G06T 19/20; G06T 5/30; G06T 5/77; G06T 7/11; G06T 17/20; G06T 19/00

(52) U.S. Cl. CPC G06T 19/20; G06T 5/30; G06T 5/77; G06T 7/11; G06T 17/20; G06T 19/006; G06T 2207/30201

(57) ABSTRACT

Systems and methods for dynamic image modification. One such method includes receiving an image depicting a subject object having a true feature and generating, by a segmentation model, a mask associated with the true feature. The method further includes applying an illustrated mask to the image to generate a modified image, the illustrated mask depicting an illustration of the subject object corresponding to an area of the mask with the true feature removed, and generating a three-dimensional (3D) mesh of the subject object based on the modified image. The method further includes applying a 3D artificial feature to the 3D mesh, the 3D artificial feature belonging to a same feature-type as the true feature, and generating a completed 3D mesh of the modified image having the true feature removed and other features related to the subject object preserved, and including a photorealistic addition of the 3D artificial feature.

### BACKGROUND

Augmented reality (AR) experiences are increasingly being utilized in various aspects of retail and commerce. For example, instead of going to a brick-and-mortar store to view physical products for purchase, more and more, consumers are turning to AR experiences to view representations of products in an AR setting. Additionally, AR can be utilized in various other aspects of commerce, such as in areas related to a user's appearance. However, current systems for generating AR images associated with a user's appearance are frequently limited, such that AR representation of a desired new element may overlap an actual real-world element in the image. This results in generation of AR images which are inaccurate and unhelpful to users.

### SUMMARY

The disclosed examples are described in detail below with reference to the accompanying drawing figures listed below. The following summary is provided to illustrate some examples disclosed herein.

Disclosed are various systems and methods for removing, replacing, and/or changing existing user features during augmented reality experiences. In some examples, an image depicting a subject object having a true feature is received. A segmentation model generates a mask associated with the true feature. An illustrated mask is applied to the image to generate a modified image. The illustrated mask depicts an illustration of the subject object corresponding to an area of the mask with the true feature removed. A three-dimensional (3D) mesh of the subject object is generated based on the modified image. A 3D artificial feature is applied to the 3D mesh. The 3D artificial feature belongs to a same feature-type as the true feature. A completed 3D mesh of the modified image having the true feature removed and other features related to the subject object preserved and including a photorealistic addition of the 3D artificial feature, is generated.

### BRIEF DESCRIPTION OF THE DRAWINGS

The disclosed examples are described in detail below with reference to the accompanying drawing figures listed below:

FIG. 1 is a block diagram illustrating an example system for removing and replacing user features for an augmented reality experience;

FIG. 2 is a block diagram illustrating an example system for removing and replacing user features for an augmented reality experience;

FIGS. 3A and 3B illustrate image segmentation operations performed to generate feature masks;

FIGS. 4A and 4B illustrate dilation operations performed to generate dilated features masks;

FIG. 5 illustrates utilizing a diffusion model in removing a feature from an image to generate a modified image; and

FIG. 6 illustrates using the modified image of FIG. 5 to generate a 3D mesh of the image, and using the 3D mesh for generating an augmented reality experience including an artificial feature; and

FIG. 7 is a flowchart illustrating a method for removing and replacing user features for an augmented reality experience, such as by using the system of FIG. 1 or the system of FIG. 2, for example.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some embodiments, . . . ” For brevity and clarity of presentation, this implied leading clause is not repeated ad nauseum.

In cosmetic or appearance-related AR applications, users utilize AR to see what they would look like with new personal items or features, such as a new hair style, new makeup, or a new pair of new eyeglasses, for example. Traditional AR systems often inaccurately depict these new appearance-related features, as many current systems simply apply a representation of a desired feature on top of a current feature worn by the user while partaking in the AR experience. For example, a user may wish to “try on” a new pair of eyeglasses via an AR experience, but would have to take off their actual pair of eyeglasses to do so, as the AR experience would inaccurately depict the new pair of glasses on top of their actual pair of glasses. The user having to remove their actual eyeglasses to perform the AR experience involves its own issues, as the person may not be able to see the results of the AR experience without wearing their glasses. Or, similarly, a user would not want to shave their head to participate in an AR experience for “trying out” a new hair style. Accordingly, accuracy of AR experiences can be advanced and improved if certain features related to the AR experience are removed and replaced with replacement features.

Aspects of the disclosure solve multiple problems that are rooted in computer technology and render use of computing platforms more efficient by providing improved systems and methods for removing and replacing user features during augmented reality experiences. Specifically, in some embodiments a computing device is utilized to identify and segment a true feature related to a subject object of interest from the subject object to create a mask for the feature. The computing device dilates the mask and performs image generation, such as by using a diffusion model, to create an illustrated mask that depicts an area of the subject object corresponding to the mask, but with the feature removed from the subject object. The computing device can then apply the illustrated mask to the image to generate a modified image, which depicts the subject object with the feature removed. The computing device can then generate a 3D mesh of the subject object based on the modified image and apply a 3D artificial feature to the 3D mesh to generate a completed 3D mesh, where the 3D artificial feature is a same type of feature as the feature removed from the image. The completed 3D mesh can then be applied to streaming data of the user to provide for an augmented reality experience where, in real time, the subject object is depicted with the feature removed, and with the 3D artificial feature applied to the subject object.

In some embodiments, the subject object is a user's face, and the feature removed from the user's face by the computing device for augmented reality experience is a pair of eyeglasses actually worn by the user while interacting with the augmented reality experience. Thus, the 3D artificial feature is a pair of virtual eyeglasses that the user has selected to “try on” via the augmented reality experience. Thereby, the user is provided with an accurate depiction of what they would look like with the current eyeglasses removed and the virtual eyeglasses being worn without actually having to physically remove their eyeglasses.

According to some embodiments, the computing device generates a feature mask related to the feature to be removed for the AR experience, and image generation and/or inpainting by a diffusion model is only performed within, and/or in adjacent areas to, the masked area. Thereby, image generation and/or inpainting by a diffusion model is focused on only specific areas of an image rather than the entire image, providing for efficient use of available processing and storage resources.

According to various embodiments, the computing device generates a dilated feature mask related to the feature, where the dilation is performed based on a detected size of the subject object. Thereby, the amount of image generation for the illustrated mask is dependent on the size of the subject object, providing for efficient use of available processing and storage resources.

According to various embodiments, the computing device generates a 3D mesh based on a modified image of the subject object, where the modified image is only modified in regions related to the masked area. Thereby, the 3D mesh more-accurately depicts the subject object and is in improved condition for use in generating an augmented reality experience.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

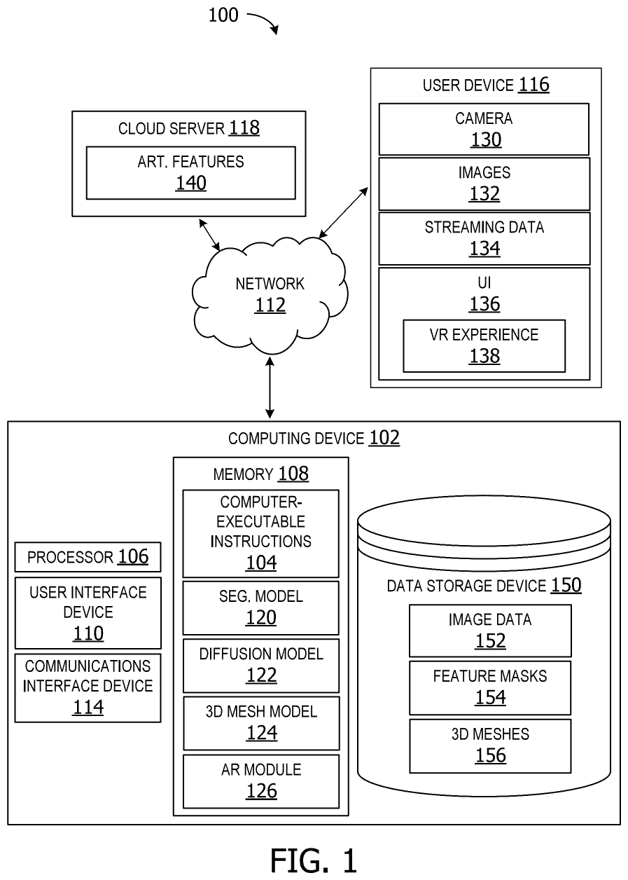

FIG. 1 illustrates an example block diagram of a system 100 for removing and replacing user features for an augmented reality experience. In the example of FIG. 1, computing device 102 represents any device executing computer-executable instructions 104 (e.g., as application programs, operating system functionality, or both) to implement the operations and functionality associated with the computing device 102. Computing device 102 can represent a group of processing units or other computing devices. In some embodiments, the computing device 102 has at least one processor 106 and a memory 108. Computing device 102, in other embodiments includes a user interface device 110.

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, processor 106 is programmed to execute instructions such as those illustrated in the figures.

The computing device 102 further has one or more computer-readable media such as the memory 108. The memory 108 includes any quantity of media associated with or accessible by the computing device 102. The memory 108 in these examples is internal to computing device 102 (as shown in FIG. 1). In other embodiments, the memory 108 is external to the computing device (not shown) or both (not shown). The memory 108 can include a read-only memory and/or memory wired into an analog computing device.

The memory 108 stores data, such as one or more applications, such a segmentation model 120 configured to segment objects from images, such as images from user device 116, for example; a diffusion model 122 configured to perform image generation and/or inpainting; a 3D mesh model 124 configured to generate three dimensional (3D) meshes based on two-dimensional (2D) input data; and an augmented reality (AR) and virtual reality (VR) module 126 configured to generate AR and/or VR experiences using the meshes from 3D mesh model 124. The applications, when executed by processor 106, operate to perform functionality on the computing device 102. The applications can communicate with counterpart applications or services such as web services accessible via a network 112 or multiple communication networks 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

Network 112 is implemented by one or more physical network components, such as, but without limitation, routers, switches, network interface cards (NICs), and other network devices. Network 112 is any type of network for enabling communications with remote computing devices, such as, but not limited to, a local area network (LAN), a subnet, a wide area network (WAN), a wireless (Wi-Fi) network, or any other type of network. In this example, network 112 is a WAN, such as the Internet. However, in other embodiments, the network 112 is a local or private LAN.

In some embodiments, computing device 102 optionally includes a communications interface device 114. The communications interface device 114 includes a network interface card and/or computer-executable instructions (e.g., a driver) for operating the network interface card. Communication between the computing device 102 and other devices, such as but not limited to user device 116, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. User device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device can include a camera 130 configured to gather image data used by computing device 102 in generating AR experiences. Image capture device 130 can store and/or capture images 132 utilized by computing device 102 in generating AR experiences. Additionally, image capture device 130 can generate streaming data 134 utilized by computing device 102 in generating AR experiences. User device 116 includes a user interface 136, substantially the same as user interface device 110 previously discussed. Via user interface 136, AR/VR module 126 can display to the user an interactive AR experience 138.

The cloud server 118 is a logical server providing services to the computing device 102 or other clients, such as, but not limited to, the user device 116. Cloud server 118 is hosted and/or delivered via the network 112. In some non-limiting examples, cloud server 118 is associated with one or more physical servers in one or more data centers. In other embodiments, the cloud server 118 is associated with a distributed network of servers. Cloud server 118 optionally stores artificial features 140 that are selectable by a user via user device 116 and incorporated into an AR experience 138 by AR/VR module 126.

The system 100 can optionally include a data storage device 150 for storing data, such as, but not limited to, image data 152 from user device 116; feature masks 154 generated by segmentation model 120 and modified by diffusion model 122; and 3D meshes 156 generated by 3D mesh model 124. The data storage device 134 can include one or more different types of data storage devices, such as, for example, one or more rotating disks drives, one or more solid state drives (SSDs), and/or any other type of data storage device. The data storage device 134 in some non-limiting examples includes a redundant array of independent disks (RAID) array. In some non-limiting examples, the data storage device(s) provide a shared data store accessible by two or more hosts in a cluster. For example, the data storage device can includes a hard disk, a redundant array of independent disks (RAID), a flash memory drive, a storage area network (SAN), or other data storage device. In other embodiments, the data storage device 150 includes a database.

The data storage device 150 in this example is included within the computing device 102, attached to the computing device, plugged into the computing device, or otherwise associated with the computing device 102. In other embodiments, data storage device 150 includes a remote data storage accessed by the computing device via the network 112, such as a remote data storage device, a data storage in a remote data center, or a cloud storage. Similarly, although segmentation model 120, diffusion model 122, 3D mesh model 124, and AR/VR module 126 are depicted within computing device 102, according to various embodiments, these applications are implemented on a remote or cloud memory storage.

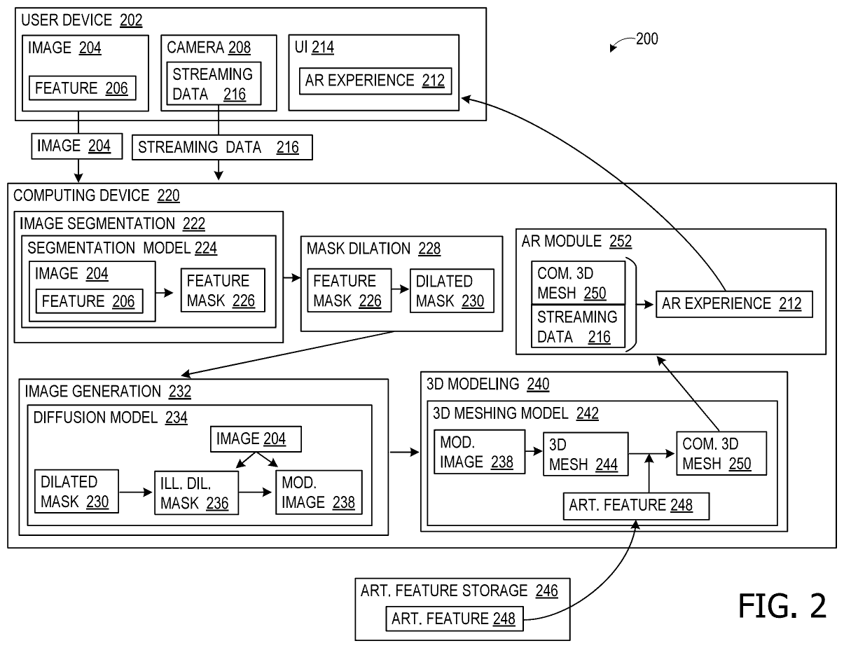

FIG. 2 is a block diagram illustrating a system 200 for providing augmented reality experiences. Those with skill in the art will recognize that various elements of system 200 correspond with and/or are analogous to elements of system 100 previously discussed. System 200 includes a user device 202 which stores and/or is able to capture images, such as image 204. As will be discussed in greater detail below, image 204, in some examples, is an image of a person and includes a person's face. However, the embodiments are not limited to images of a person's face.

Additionally, image 204 depicts a feature or element, such as feature 206. As will be discussed in greater detail below, feature 206 can be a feature associated with a person's face, such as a pair of eyeglasses, for example. As those with skill in the art will understand, image 204 can be stored to a memory of user device 202 and/or can be captured by a camera 208 of user device 202. As will be discussed in greater detail below, in some examples, a user interacts with user device 202 and provides image 204 in order to engage in an AR experience 212 displayed on a user interface (UI) 214.

In initiating AR experience 212, user device 202 delivers image 204, and also streaming data 216 from camera 208, to a computing device 220. Streaming data 216, in some examples, is data captured by camera 208 that is used in providing AR experience 212. Streaming 204, in some examples, is a real-time video or livestream data recording a user's face that is to be incorporated into the AR experience 212.

Computing device 220, in some examples, performs image segmentation 222 on image 204 using a segmentation model 224. During image segmentation 222, computing device 220 identifies and segments feature 206 from the rest of image 204 and thereby generates a feature mask 226 corresponding to feature 206. Computing device 220 then performs mask dilation 228 where feature mask 226 is uniformly dilated or enlarged to generate a dilated mask 230. As will be discussed in greater detail below, mask dilation 228 can be performed using a variable normalization factor that is dependent on details of image 204. For example, in some embodiments, the normalization factor corresponds to a detected size of the face depicted in image 204.

Computing device 220, in some embodiments, performs image generation 232, such as by utilizing a diffusion model 234. In some embodiments, diffusion model 234 is a stable diffusion model. As those with skill in the art will understand, diffusion model 234 is a generative artificial intelligence (AI) model used for image generation. Any of various generative AI models can be utilized as diffusion model 234 without departing from the scope of this disclosure. Using image 204 and dilated mask 230, diffusion model 234 generates an illustrated dilated mask 236 depicting what the area corresponding to dilated mask 230 of image 204 would look like with feature 206 removed from image 204. Diffusion model 234 then applies illustrated dilated mask 236 to image 204 to generate a modified image 238, which depicts what the entire image 204 would look like with feature 206 removed from the image. Thus, diffusion model 234 focuses on performing image generation on only the area of image 104 associated with feature 206 by performing image generation on areas associated with dilated mask 230 in generating illustrated dilated mask 236.

Computing device 220 may perform three-dimensional (3D) modeling 240 utilizing a 3D mesh model 242. Specifically, 3D mesh model 242 can receive modified image 238 and generate 3D mesh 244 from modified image 238. In some examples, as discussed, modified image 238 depicts a face as the subject object, and thus 3D mesh model 242 generates a 3D mesh 244 that is a 3D mesh of the face depicted in modified image 238. During 3D modeling 240, 3D mesh model 242 can further retrieve an artificial feature 248 from an artificial feature storage 246. In some embodiments, artificial feature 248 is a feature chosen by the user in establishing the AR experience 212, such as by a selection or indication made via UI 214. In some embodiments, the artificial feature 248 is the same type of feature as feature 206. In some examples, feature 206 detected and segmented from image 204 is a pair of eyeglasses worn by the user, and thus artificial feature 248 can be a 3D model representation of a new pair of eyeglasses desired to be worn by the user during the AR experience 212. Artificial feature storage 246 can be a database storing various artificial features, and retrieval of artificial feature 248 by 3D mesh model 242 can be done based on the specific selections or indications made by the user. 3D mesh model 242 may apply artificial feature 248 to 3D mesh 244 to generate a completed 3D mesh 350. For example, in keeping with the illustrative example already discussed, in some embodiments, completed 3D mesh 250 comprises a 3D mesh of a face (3D mesh 244) wearing newly selected eyeglasses (artificial feature 248).

Completed 3D mesh 250, in some embodiments, is delivered to an AR module 252 responsible for generating AR experience 212. AR module 252 can use 3D mesh 250 and streaming data 216 to generate the AR experience 212, which is displayed to the user via UI 214. For example, streaming data 216 can include recordings of a user's face in real-time, and 3D mesh 250 can be mapped to the user's face by AR module 252 to provide an AR experience 212 depicting the user with an artificial feature 248, such as, but not limited to, a new pair of eyeglasses depicted on the user's face in the modified image. Those with skill in the art will understand that, while an AR experience is discussed herein an illustrative example, according to various embodiments of this disclosure, 3D mesh 250 is used in generating VR experiences.

Those with skill in the art will understand that while one user device 202 is depicted, numerous user devices can be used as part of system 200 according to various embodiments of this disclosure. For example, one user device can be used to provide image 204, a separate user device can be used to provide streaming data 216, and a separate user device can be used for viewing AR experience 212 via UI 214.

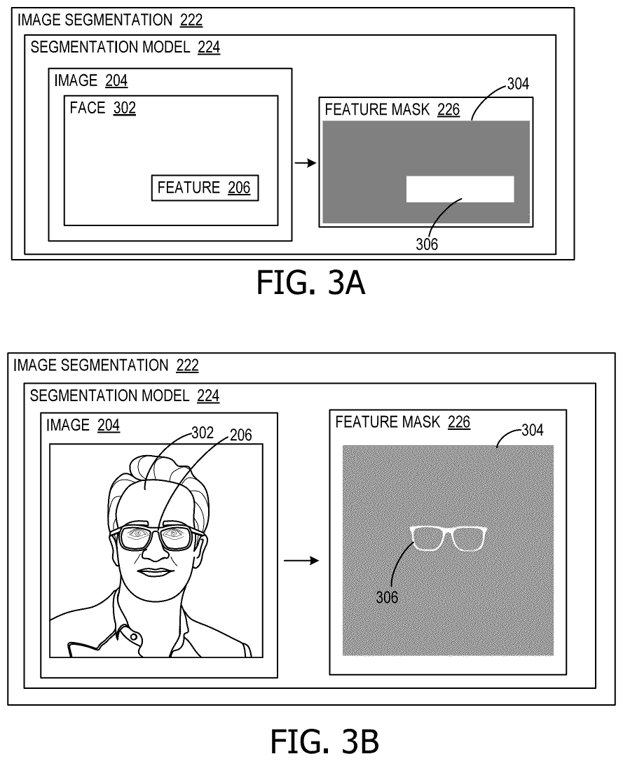

FIGS. 3A and 3B illustrate how image segmentation 222 is performed on image 204 using segmentation model 224. Segmentation model 224 can be any of various known segmentation models used for image segmentation, including various artificial intelligence (AI) and machine learning (ML) models and systems designed and trained to partition an image into multiple segments or regions based on different objects or parts identified in the image. For example, in some embodiments, DeepLabV3 is used as segmentation model 224, but those with skill in the art will understand that various similar segmentation models are included as part of this disclosure.

Segmentation model 224 is trained to identify and segment feature 206 from image 204 to generate feature mask 226. As shown, in some embodiments, image 204 includes a face 302 of a user, and feature 206 is a feature or element associated with face 302. Feature mask 226 includes a mask region 304 and a feature region 306. As shown, feature region 306 corresponds to the shape and location of feature 206 positioned on image 204. That is, mask region 304 masks all of image 204 not associated with the identified feature 206, leaving only feature region 306.

Although a face 302 is used as a subject object of image 204 in this and various other illustrative examples of this disclosure, those with skill in the art will understand that the methods and systems disclosed herein can be applied for images depicting any of various subject objects, not just faces. That is, image segmentation 222, image generation 232, and 3D modeling 240 discussed herein can be performed using images of various different subject objects and associated true features associated with the subject object. A face 302 is one type of subject object, but various other subject objects and associated features fall within the scope of this disclosure. For example, in some embodiments, the subject object can be a human, animal, inanimate object, room, area, or any other subject captured in an image. Additionally, feature 206 is described as a true feature of face 302, and is described herein as eyeglasses. However, according to various embodiments, feature 206 can be any true feature associated with a subject object, such as facial/body features, inanimate objects, clothing, hair, furniture, or any other true feature associated with the subject object of an image, for example.

FIG. 3B shows an illustrative example of an image 204 of face 302 and the associated feature mask 226 generated by segmentation model 224. As shown, in this illustrative example, the feature 206 associated with face 302 is a pair of eyeglasses. While eyeglasses are shown as a feature 206 in this illustrative example, those with skill in the art will recognize that feature 206 associated with face 302 can any facial feature, such as hair, facial hair, or makeup for example. Additionally, in some examples, features could even be structural facial features such as ears, eyebrows, nose, or other facial features, thereby enabling use of architecture 100 and 200 for cosmetology and/or plastic surgery applications. Further, while features related to a user face are discussed, those with skill in the art will understand that the systems and method discussed herein can be applied for various types of subject objects, including those not related to faces, where it is desired to remove and replace certain features of a subject object with related artificial features for an AR experience.

In this illustrative example, segmentation model 224 is trained to identify and segment eyeglasses on a face 302. As shown, the resulting feature mask 226 illustrates feature region 306 corresponding to the shape of the eyeglasses identified as feature 206, and is also positioned in mask region 304 of feature mask 226 in the same positions as feature 206 in image 204.

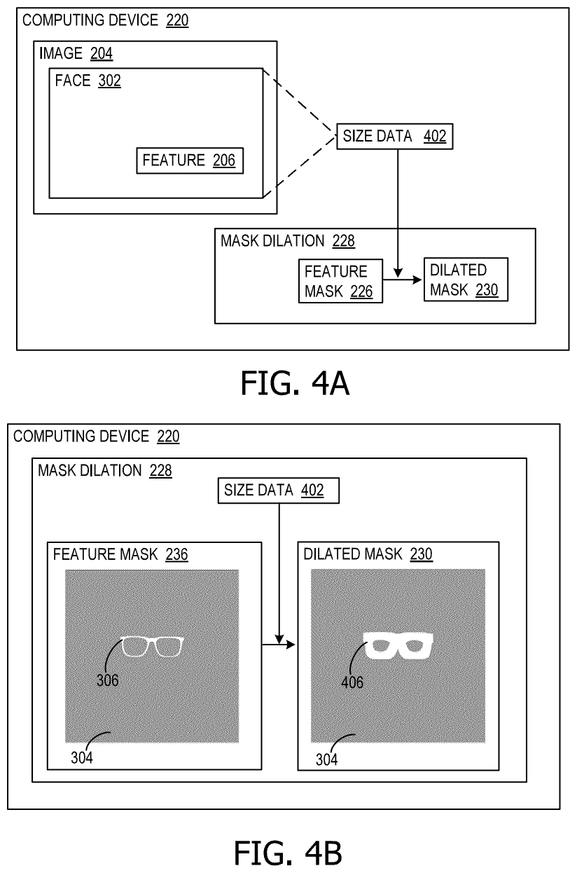

FIGS. 4A and 4B illustrate how data related to image 204 may be gathered by computing device 220 and utilized as part of mask dilation 228. As shown, in FIG. 4A, computing device 220 can gather size data 402 related to certain objects detected in image 204 by segmentation model 224. For example, segmentation model 224 can identify face 302 and also determine the size or measurements of face 302. Accordingly, size data 402 can relate to the size of face 302 or certain features of face 302. As shown, the size data 402 is then used during mask dilation 228 to generate dilated mask 230.

Referring to FIG. 4B, computing device 220 can perform mask dilation 228 according to size data 402. In some examples, illustrated dilated mask 236 is dilated using a normalization factor that is based on size data 402. As shown, dilated mask 230 includes a dilated feature region 406 that represents a dilated version of feature region 306. Dilated feature region 406 is uniformly dilated compared to feature region 306. Dilation can be based on size data 402, such as the determined size of face 302. That is, dilated feature region 406 is more dilated in response to size data 402 representing a large face, and is less dilated in response to size data 402 representing a small face.

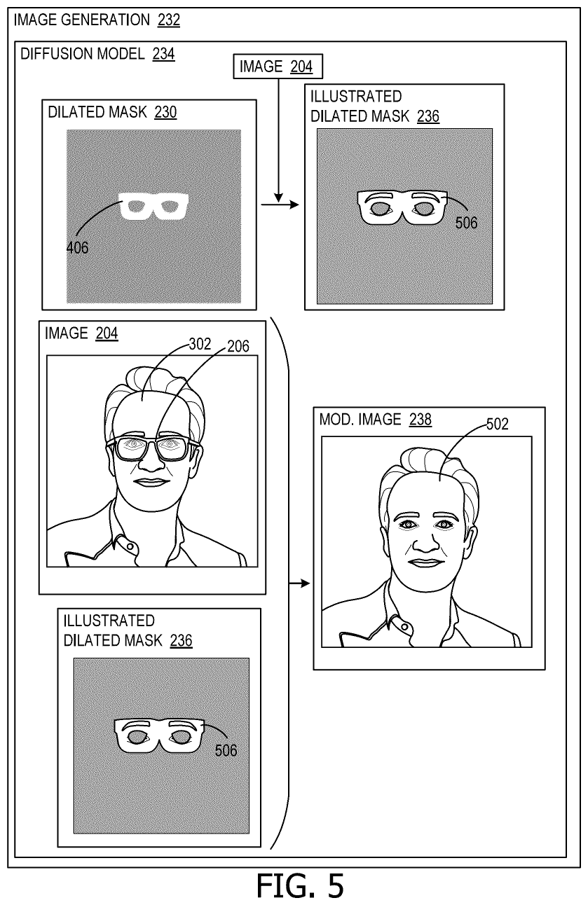

FIG. 5 illustrates how computing device 220 performs image generation 232 using diffusion model 234. As those with skill in the art will understand, diffusion model 234 can be any of various ML and/or AI diffusion models used to perform image generation and/or inpainting. For example, according to some embodiments, diffusion model 234 comprises or includes the Stable Diffusion model.

Diffusion model 234 is trained to perform image generation and inpainting using dilated feature region 406 of dilated mask 230 to generate illustrated dilated mask 236. Illustrated dilated mask 236 can also be referred to as an inpainted mask, as diffusion model 234 performs generative AI inpainting to fill in missing parts of dilated mask 230. Diffusion model 234 compares dilated mask 230 and image 204 to inpaint dilated feature region 406 of a corresponding region of face 302, depicting the region with feature 206 removed from image 204. The result is illustrated dilated mask 236 including an inpainted region 506, representing an inpainted representation of face 302 corresponding to dilated feature region 406 with feature 206 removed.

Diffusion model 234 then generates modified image 238 with a modified face 502 by combining image 204 and illustrated dilated mask 236. As shown, modified face 502 of modified image 238 depicts face 302 with feature 206 removed.

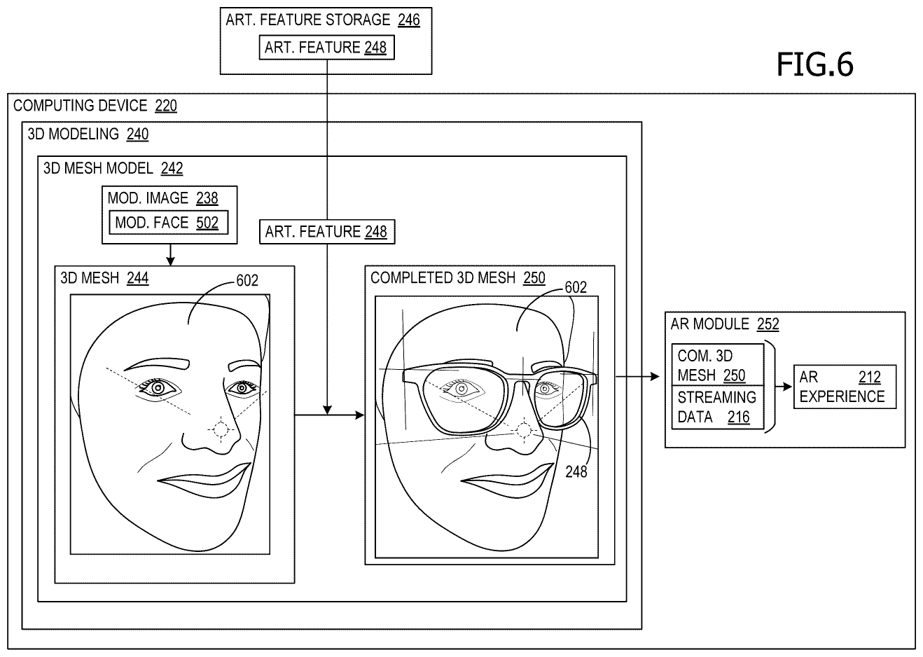

FIG. 6 illustrates 3D modeling 240 performed by computing device 220 using 3D mesh model 242. 3D mesh model, in some examples, comprises any of various known models, tools, applications, and/or software used for forming 3D models meshes, or representations, such as 3D meshes representing two-dimensional (2D) input data. 3D mesh model 242 is provided with modified image 238 and is configured to generate a 3D mesh 244 of modified image 238. Specifically, 3D mesh 244 includes a 3D model face 602 representation of modified face 502.

Computing device 220 receives artificial feature 248 from artificial feature storage 246. In some embodiments, artificial feature 248 is a 3D model belonging to a same feature type as feature 206. For example, in the illustrative examples discussed herein, feature 206 is a pair of eyeglasses, and artificial feature 248 is a 3D model of a pair of eyeglasses. Artificial feature storage 246 can include numerous artificial features that can be viewed and selected by the user via UI 214. For example, as will be clear to those with skill in the art, AR experience 212 can be a “virtual try-on” (VTO) experience where the user performs the AR experience 212 to try on a new pair of eyeglasses. The user can browse and select various eyeglasses options (artificial features 248) available in artificial feature storage 246 to try on during the VTO via UI 214. Computing device 220 retrieves the selected artificial feature 248 and provides it to 3D mesh model 242 for including in completed 3D mesh 250. As shown, in completed 3D mesh, the 3D mesh model 242 inserts the artificial feature 248 on the 3D model face 602.

Computing device 220 provides the completed 3D mesh 250 to AR module 252, where AR module 252 uses completed 3D mesh 250 together with streaming data 216 to provide AR experience 212. For example, corresponding locations of completed 3D mesh 250 can be identified and mapped to the user's face found in streaming data 216 such that the augmented reality experience 212 displays the user without feature 206 and wearing artificial feature 248. That is, in the streaming data 216, the user's face can include feature 206, and AR experience 212 displays the user's face with feature 206 removed and artificial feature 248 included.

Those with skill in the art will the various benefits enabled by system 200. Specifically, the user can partake in AR experience 212 to perform a VTO without having to remove their existing feature 206. In keeping with the illustrative example discussed herein, that means a user can wear their existing glasses (feature 206) while performing the VTO to see what they would look like with a new pair of glasses (artificial feature 248). Without being able to wear their actual glasses during the VTO, the user may not be able to see the results of the AR experience 212, and thus not be able to see what they look like with the new glasses, thereby defeating the entire purpose of performing the VTO. Thus, system 200 enables a user to keep their glasses on and still take part in an accurate AR experience 212 where they can perform a VTO to try on new eyeglasses.

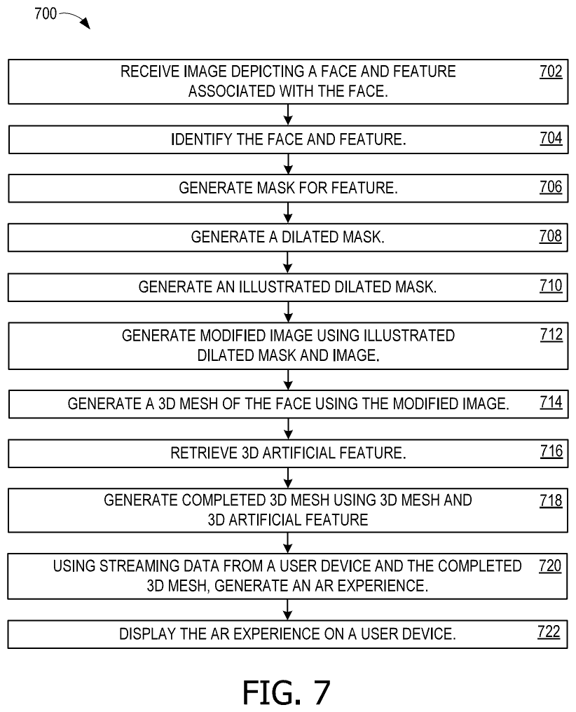

FIG. 7 includes a flowchart illustrating a method 700 for performing dynamic image modification by providing for removing and replacing user features during an augmented reality experience, such as by using the system 100 or system 200, for example.

Method 700 can begin at block 702 by computing device 220 receiving an image 104, such as receiving image 204 from user device 202. Method 700 can continue to block 704 where computing device 220 identifies a subject object and associated feature of image 204. For example, the subject object can be face 302 and feature 206 can be a pair of eyeglasses on face 302, as has been previously discussed. In some embodiments, block 704 further comprises detecting the size of face 302 and generating size data 402.

Method 700 can continue to block 706 where computing device 220 performs image segmentation 222 using segmentation model 224 to generate feature mask 226 for feature 206. Method 700 can continue to block 708 where computing device 220 performs mask dilation 228 to generate dilated mask 230 from feature mask 226. As previously discussed, in some embodiments, computing device 220 utilizes a normalization factor for generating dilated mask 230, and the normalization factor can be based on the size data 402 related to the size of face 302.

Method 700 can continue to block 710 where computing device 220 performs image generation 232 using diffusion model 234 to generate illustrated dilated mask 236 from dilated mask 230. Method 700 can continue to block 712 where computing device 220 generates modified image 238 by applying illustrated dilated mask 236 to image 204.

Method 700 can continue to block 714 where computing device 220 performs 3D modeling 240 using 3D mesh model 242 to generate 3D mesh 244 of modified image 238. For example, 3D mesh 244 can be a 3D mesh of modified face 502, which is face 302 from image 204 with feature 206 removed. Method 700 can continue to block 716 where computing device 220 retrieves artificial feature 248 from artificial feature storage 246. In some embodiments, computing device 220 identifies and retrieves the artificial feature 248 based on a user-provided indication identifying the artificial feature 248 for use in AR experience 212, such as an indication made via UI 214, for example. Method 700 can continue to block 718 where computing device 220, via 3D mesh model 242, applies artificial feature 248 to 3D mesh 244 to generate completed 3D mesh 250.

Method 700 can continue to block 720 where computing device 220, via AR module 252, receives streaming data 216 from user device 202 and maps and applies completed 3D mesh 250 to streaming data 216 to generate AR experience 212. Specifically, as has been discussed herein, AR experience 212 removes feature 206 from the face 302 of the user found in streaming data 216 and adds to the face artificial feature 248 so as to provide an AR experience where the user can “try on” the artificial feature 248 without having to physically remove feature 206. Method 700 can continue to block 722, where the AR experience 212 is displayed to the user, such as by UI 214, for example.

While FIG. 7 depicts blocks 702-722 occurring according to a certain order, those with skill in the art will understand that method 700 can comprise performing blocks 702-722 according to any of various order, according to various embodiments of this disclosure. Additionally, those with skill in the art will understand that method 700 can comprise more or fewer than the blocks 702-722 depicted, according to various embodiments of this disclosure.

### Additional Examples

In an example scenario, the systems herein (such as system 100 and 200, for example) are utilized by retailers, such as for providing “virtual try-ons” of products offered by the retailer. The system can receive an image depicting a subject object having a true feature and generating, by a segmentation model, a mask associated with the true feature. The system can further apply an illustrated mask to the image to generate a modified image, the illustrated mask depicting an illustration of the subject object corresponding to an area of the mask with the true feature removed, and generate a three-dimensional (3D) mesh of the subject object based on the modified image. The system can further apply a 3D artificial feature to the 3D mesh, the 3D artificial feature belonging to the same feature-type as the true feature, and generate a completed 3D mesh of the modified image having the true feature removed and other features related to the subject object preserved, and including a photorealistic addition of the 3D artificial feature.

For example, in some embodiments, the subject object is the face of a user, and the product offered by the retailer is a pair of eyeglasses, represented by the 3D artificial feature. The user can “try on” the virtual eyeglasses during an AR experience that utilizes the completed 3D mesh without having to remove their physical eyeglasses.

Alternatively, or in addition to the other examples described herein, examples include any combination of the following:
dilating the mask using a normalization factor to generate a dilated mask; and generating, using a diffusion model, the illustrated mask based on the dilated mask.
determining a size of the subject object from the image, wherein the normalization factor is based on the size of the subject object.
where the diffusion model utilizes inpainting techniques in generating the illustrated mask.
receiving a user indication related to a selection of the 3D artificial feature; and retrieving the 3D artificial feature from an artificial feature storage storing a plurality of 3D artificial features based on the user indication.
displaying an augmented reality experience using the completed 3D mesh, the augmented reality experience depicting the subject object with the true feature replaced by the 3D artificial feature.

At least a portion of the functionality of the various elements in FIG. 1 can be performed by other elements in FIG. 1, or an entity (e.g., processor 106, web service, server, application program, computing device, etc.) not shown in FIG. 1.

In some examples, the operations illustrated in FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of performing dynamic image modification, the method comprising: receiving an image depicting a subject object having a true feature; generating, by a segmentation model, a mask associated with the true feature; applying an illustrated mask to the image to generate a modified image, the illustrated mask depicting an illustration of the subject object corresponding to an area of the mask with the true feature removed; generating a three-dimensional (3D) mesh of the subject object based on the modified image; applying a 3D artificial feature to the 3D mesh, the 3D artificial feature belonging to a same feature-type as the true feature; and generating a completed 3D mesh of the modified image having the true feature removed and other features related to the subject object preserved and including a photorealistic addition of the 3D artificial feature.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Example Operating Environment

Although described in connection with an example computing device 102, 220, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method for dynamic image modification, the method comprising:
receiving an image depicting a subject object having a true feature;
generating, by a segmentation model, a mask associated with the true feature;
applying an illustrated mask to the image to generate a modified image, the illustrated mask depicting an illustration of the subject object corresponding to an area of the mask with the true feature removed;
generating a three-dimensional (3D) mesh of the subject object based on the modified image;
applying a 3D artificial feature to the 3D mesh, the 3D artificial feature belonging to a same feature-type as the true feature; and
generating a completed 3D mesh of the modified image having the true feature removed and other features related to the subject object preserved and including a photorealistic addition of the 3D artificial feature.

2. The method of claim 1, further comprising:
dilating the mask using a normalization factor to generate a dilated mask; and
generating, using a diffusion model, the illustrated mask based on the dilated mask.

3. The method of claim 2, further comprising:
determining a size of the subject object from the image, wherein the normalization factor is based on the size of the subject object.

4. The method of claim 2, wherein the diffusion model utilizes inpainting techniques in generating the illustrated mask.

5. The method of claim 1, further comprising:
receiving a user indication related to a selection of the 3D artificial feature; and
retrieving the 3D artificial feature from an artificial feature storage storing a plurality of 3D artificial features based on the user indication.

6. The method of claim 1, further comprising:
displaying an augmented reality experience using the completed 3D mesh, the augmented reality experience depicting the subject object with the true feature replaced by the 3D artificial feature.

7. The method of claim 1, wherein:
the subject object is a person's face; and
the feature-type of the true feature and the 3D artificial feature is a pair of eyeglasses.

8. A system for dynamic image modification, the system comprising:
a processor; and
a computer-readable medium storing instructions that are operative upon execution by the processor to:
receive an image depicting a subject object having a true feature;
generate, by a segmentation model, a mask associated with the true feature;
apply an illustrated mask to the image to generate a modified image, the illustrated mask depicting an illustration of the subject object corresponding to an area of the mask with the true feature removed;
generate a three-dimensional (3D) mesh of the subject object based on the modified image;
apply a 3D artificial feature to the 3D mesh, the 3D artificial feature belonging to a same feature-type as the true feature; and
generate a completed 3D mesh of the modified image having the true feature removed and other features related to the subject object preserved and including a photorealistic addition of the 3D artificial feature.

9. The system of claim 8, wherein the computer-readable medium further stores instructions operative by the processor to:
dilate the mask using a normalization factor to generate a dilated mask; and
generate, using a diffusion model, the illustrated mask based on the dilated mask.

10. The system of claim 9, wherein the computer-readable medium further stores instructions operative by the processor to:
determine a size of the subject object from the image, wherein the normalization factor is based on the size of the subject object.

11. The system of claim 9, wherein the diffusion model utilizes inpainting techniques in generating the illustrated mask.

12. The system of claim 8, wherein the computer-readable medium further stores instructions operative by the processor to:
receive a user indication related to a selection of the 3D artificial feature; and
retrieve the 3D artificial feature from an artificial feature storage storing a plurality of 3D artificial features based on the user indication.

13. The system of claim 8, wherein the computer-readable medium further stores instructions operative by the processor to:
display an augmented reality experience using the completed 3D mesh, the augmented reality experience depicting the subject object with the true feature replaced by the 3D artificial feature.

14. The system of claim 8, wherein:
the subject object is a person's face; and
the feature-type of the true feature and the 3D artificial feature is a pair of eyeglasses.

15. A computer-readable medium storing instructions for dynamic image modification, the instructions operative upon execution by a processor to:
receive an image depicting a subject object having a true feature;
generate, by a segmentation model, a mask associated with the true feature;
apply an illustrated mask to the image to generate a modified image, the illustrated mask depicting an illustration of the subject object corresponding to an area of the mask with the true feature removed;
generate a three-dimensional (3D) mesh of the subject object based on the modified image;
apply a 3D artificial feature to the 3D mesh, the 3D artificial feature belonging to a same feature-type as the true feature; and
generate a completed 3D mesh of the modified image having the true feature removed and other features related to the subject object preserved and including a photorealistic addition of the 3D artificial feature.

16. The computer-readable medium of claim 15, further storing instructions operative by the processor to:
dilate the mask using a normalization factor to generate a dilated mask; and
generate, using a diffusion model, the illustrated mask based on the dilated mask.

17. The computer-readable medium of claim 16, further storing instructions operative by the processor to:
determine a size of the subject object from the image, wherein the normalization factor is based on the size of the subject object.

18. The computer-readable medium of claim 15, further storing instructions operative by the processor to:
receive a user indication related to a selection of the 3D artificial feature; and
retrieve the 3D artificial feature from an artificial feature storage storing a plurality of 3D artificial features based on the user indication.

19. The computer-readable medium of claim 15, further storing instructions operative by the processor to:
display an augmented reality experience using the completed 3D mesh, the augmented reality experience depicting the subject object with the true feature replaced by the 3D artificial feature.

20. The computer-readable medium of claim 15, wherein:
the subject object is a person's face; and
the feature-type of the true feature and the 3D artificial feature is a pair of eyeglasses.
